(19) United States
(12) Patent Application Publication
(10) Pub. No.: US 2006/0169632 A1
(43) Pub. Date: Aug. 3, 2006

(54) Filter element

(75) Inventors: Takenori Suzuki, Hamamatsu-Shi (JP); Masanori Goto, Hamamatsu-Shi (JP); Yosuke Hio, Hamamatsu-Shi (JP)

Correspondence Address: YOUNG & THOMPSON, 745 SOUTH 23RD STREET, 2ND FLOOR, ARLINGTON, VA, 22202, US

(73) Assignee: TOYO ROKI SEIZO KABUSHIKI KAISHA, HAMAMATSU-SHI (JP)

(21) Appl. No.: 11/342,545

(22) Filed: Jan. 31, 2006

(30) Foreign Application Priority Data
Jan. 31, 2005 (JP) 2005-024259

(51) Int. Cl. B01D 29/07

(52) U.S. Cl. 210/493.1

(57) ABSTRACT

There is provided a filter element which maintains the flow rate of a fluid passing through a filter medium, restrains a pressure loss as far as possible, and is compact in size. In the filter element including a filter medium 30 pleated so that peaks 30a and valleys 30b are arranged alternately and a frame 21 for holding the filter medium 30, the frame 21 includes a frame body 22 forming the peripheral edge portion thereof and a plurality of ribs 23 extending in parallel on the inside of the frame body 22. The interval H between the ribs 23 is set at 5 to 35 mm, and the filter medium 30 is folded at an angle θ of at least four degrees at the peaks 30a and the valleys 30b.

### BACKGROUND OF THE INVENTION

1. Field of the Invention

The present invention relates to a filter applied in liquid systems and, more particularly, to a filter element used in an oil filter for an automatic transmission.

2. Description of the Related Art

Conventionally, in a filter for liquid systems, such as an oil filter for an automatic transmission, there has been used a filter element in which a filter medium pleated so that peaks and valleys are arranged alternately is held on the inside of a frame.

Generally, filters have a problem in that a pressure loss is reduced by restraining the improvement in filtration efficiency and the increase in passage resistance. To solve this problem, various methods have been proposed in the past. Further, in recent years, there has been a demand for realizing a more compact filter while solving the above problem. To meet such a demand, a filter element using a pleated filter medium has often been employed. Such a filter element can have a larger filtration area because of being pleated, so that the filter element of this type is excellent in that an increase in pressure loss is prevented and the life of filter element is prolonged, and also the size of filter can be decreased.

Concerning the filter element using the pleated filter medium as described above, the applicant of the present invention has carried out many studies in the past, and has already disclosed an invention described in Patent Document 1 as one result of these studies.

[Patent Document 1] Japanese Patent Laid-Open No.2003-106417

On the other hand, the filter element of this type easily brings about an increase in passage resistance because of a filter medium sticking phenomenon. Therefore, in a case where a liquid such as oil to be filtered has a low temperature, the liquid of a desired flow rate is not allowed to pass through, which results in a disadvantage of shortened product life. Also, in a case where this filter element is used as an oil filter for an automatic transmission, there is a fear of causing malfunction of automatic transmission because of a decrease in flow rate caused by the increase in pressure loss.

### SUMMARY OF THE INVENTION

An object of the present invention is to provide a filter element capable of preventing an increase in pressure loss even in a case where a liquid such as oil to be filtered has a low temperature, and surely maintaining a desired flow rate.

In particular, regarding a filter element used as an oil filter for an automatic transmission, an object of the present invention is to properly maintain the operation of the automatic transmission.

To achieve the above object, the present invention provides a filter element (20) including a filter medium (30) pleated so that peaks (30a) and valleys (30b) are arranged alternately and a frame (21) for holding the filter medium (30), the frame (21) including a frame body (22) forming the peripheral edge portion thereof and a plurality of ribs (23) extending in parallel on the inside of the frame body (22); the interval (H) between the ribs (23) being set at 5 to 35 mm; and the filter medium (30) being arranged between the ribs (23) by being folded at an angle (θ) of at least four degrees at the peaks (30a) and the valleys (30b).

Also, in the present invention, in the filter element (20), the filter medium (30) is constructed so as to be held by the frame (21) so that the peaks (30a) and the valleys (30b) are arranged alternately in the direction in which the ribs (23) extend.

The filter medium (30) is characterized by being made up of nonwoven fabric layers (31, 32) and a reinforcing layer (33) for reinforcing the nonwoven fabric layers (31, 32).

In the present invention, regarding the frame for holding the filter medium, by setting the interval of ribs at a proper dimension, a filter medium sticking phenomenon is inhibited, and hence an increase in pressure loss is prevented through the maintenance of effective filtration area. Thereby, even in a case where a liquid such as oil to be filtered has a low temperature, the passage of fluid of a desired flow rate can surely be maintained. Especially in a case where the filter element is used for an oil filter for an automatic transmission, the increase in pressure loss is inhibited, and the flow rate of oil passing through the filter medium is secured, by which the operation of automatic transmission is maintained properly.

Also, since the filter medium is held by the frame so that the peaks and the valleys are arranged alternately in the direction in which the ribs extend, the ribs properly hold the filter medium, and therefore effectively prevents the deformation of filter medium. In addition, since the reinforcing layer is provided in the filter medium, the deformation of filter medium can further be prevented.

### BRIEF DESCRIPTION OF THE DRAWINGS

FIG. 1 is an exploded perspective view of an oil filter having a filter element in accordance with one embodiment of the present invention;

FIG. 2 is a perspective view showing one mode of layer structure of a filter medium used for the filter element shown in FIG. 1;

FIG. 3 is a perspective view showing a state in which a filter medium used for the filter element shown in FIG. 1 is folded, viewing a first structure member from the back face side;

FIG. 4 is a partial plan view partially showing the top surface of the filter element; and

FIG. 5 is a double logarithmic graph showing a relationship between flow velocity and oil passage resistance.

### DETAILED DESCRIPTION OF THE PREFERRED EMBODIMENTS

An embodiment of the present invention will now be described with reference to the accompanying drawings.

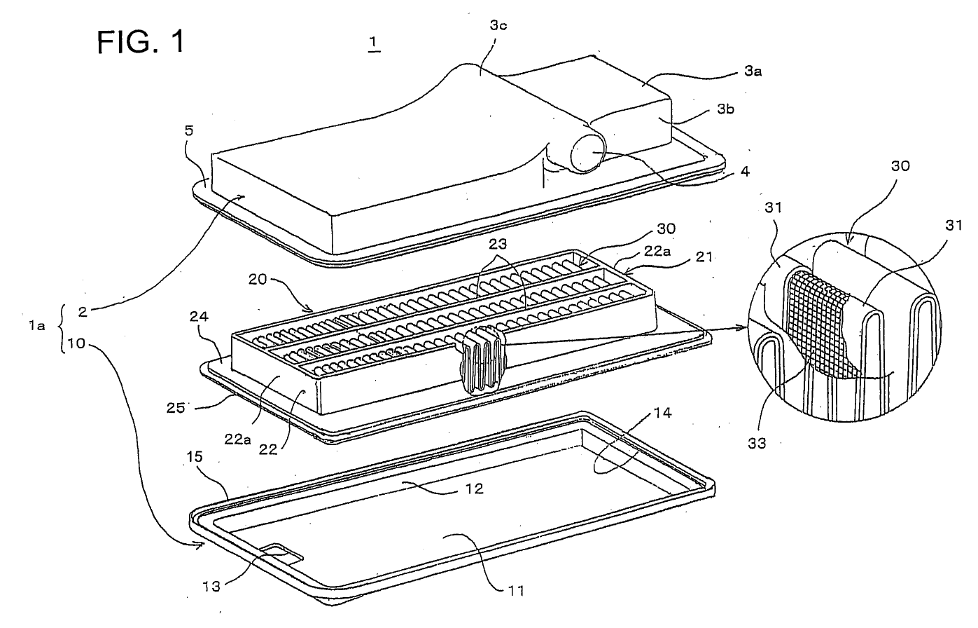

FIG. 1 shows a state in which a filter element 20 in accordance with one embodiment of the present invention is used for an oil filter 1 for an automatic transmission.

This oil filter 1 has a housing la forming a shell thereof, and the filter element 20 is contained in the housing 1a. The housing 1a is made up of a case 10 formed with an opening 14 in an upper part and a cover 2 for closing the opening 14 of the case 10.

The case 10 has an external shape formed into a rectangular shape by a bottom surface 11 and a peripheral wall surface 12 surrounding the peripheral edge of the bottom surface 11. The bottom surface 11 is formed with an inflow port 13 that allows oil to flow into the housing 1a. At the upper end of the peripheral wall surface 12 forming the opening 14, a holding flange 15 is formed over a whole circumference so as to project toward the outside having a fixed size.

On the other hand, the cover 2 has an external shape formed into a substantially rectangular shape by a top surface 3a and a peripheral wall surface 3b surrounding the periphery of the top surface 3a.In a part of the peripheral wall surface 3b, a cylindrical outflow port 4 for allowing oil to flow out of the housing 1a is formed so as to protrude toward the outside. A portion 3c of the top surface 3a corresponding to the outflow port 4 rises in an arc shape toward the upside. At the lower end of the peripheral wall surface 3b, a holding flange 5 is formed over the whole circumference so as to project having a fixed size.

The filter element 20 is contained in the housing 1a so as be held by the case 10 and the cover 2. The filter element 20 includes a frame 21 and a filter medium 30 which is arranged in the frame 21 and is held by the frame 21.

The frame 21 is integrally formed by a frame body 22, a plurality of ribs 23 extending in parallel on the inside of the frame body 22, and a flange portion 24 projecting from the outer surface of the frame body 22 toward the outside.

The frame body 22 has an external shape formed into a rectangular shape, and is formed so that the thickness and height thereof are fixed over the whole circumference. In some types of filter elements, the thickness or height is formed so as to be partially different. The thickness and the height of the frame body 22 are not limited to those formed so as to be fixed as in this embodiment.

In this embodiment, two ribs 23 extend in the lengthwise direction of the frame 21 so as to be parallel with each other, and connect opposed surfaces 22a of the frame body 22, which extend to the width wise direction. Both of the ribs 23 are formed so as to have a same height as that of the frame body 22 and a fixed thickness. The flange portion 24 projects from the outer surface of the frame body 22 toward the outside, and is formed so that the peripheral edge thereof has almost the same shape as the external shapes of the holding flanges 5 and 15 of the cover 2 and the case 10. At the outer peripheral edge of the flange portion 24, a held portion 25 having a somewhat small thickness is formed. When the filter element 20 is contained in the housing la, the held portion 25 formed in the flange portion 24 is held between the holding flanges 5 and 14 of the cover 2 and the case 10. In this embodiment, the held portion 25 is formed by decreasing the thickness of the peripheral edge part of the flange portion 24. However, the held portion 25 need not necessarily be formed so that the thickness thereof is small. Also, in this embodiment, the ribs 23 are provided so as to extend in the lengthwise direction of the frame 21. However, the configuration is not limited to this one, and the ribs 23 may be provided so as to extend in the widthwise direction of the frame 21.

In an inside portion of the frame body 22 divided into three regions by the ribs 23, filter media 30 are disposed. Each of the filter media 30 is pleated and formed into a zigzag shape so that peaks 30a and valleys 30b are arranged alternately (refer to FIG. 3). As shown in FIG. 1, the filter medium 30 is held by the frame 21 so that the peaks 30a and the valleys 30b are arranged alternately in the direction in which the ribs 23 extend.

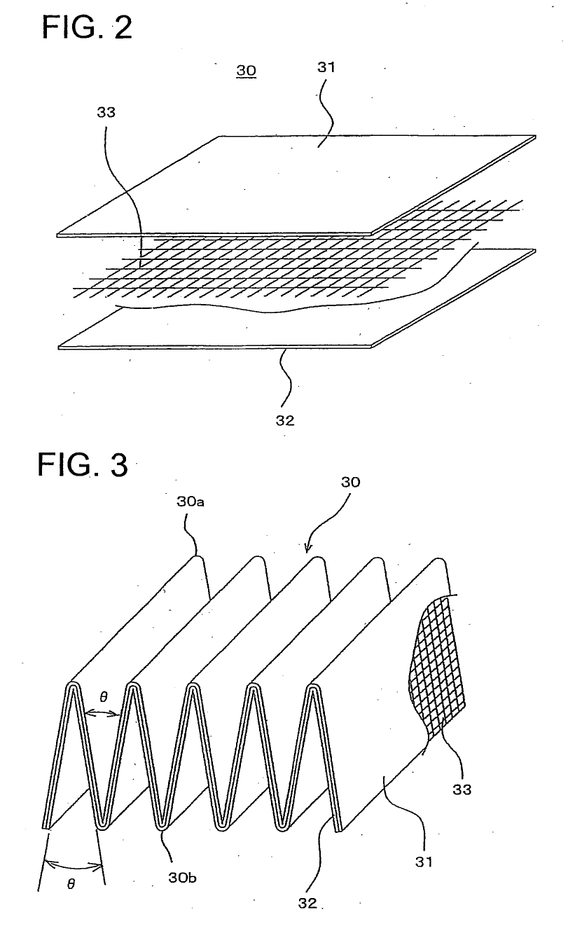

As shown in FIG. 2, the filter medium 30 is constructed by lapping an upper layer 31 and a lower layer 32, both consisting of a nonwoven fabric, with a net-shaped reinforcing sheet 33 being held therebetween. The nonwoven fabric constituting the upper layer 31 and the lower layer 32 of the filter medium 30 is formed of a material having high heat resistance, such as polyester fiber, polyamide fiber, glass fiber, and metallic fiber. On the other hand, as the reinforcing sheet 33, a material having high heat resistance, such as polyester fiber, is used.

The upper layer 31, the lower layer 32, and the reinforcing sheet 33 are lapped on each other and compressed in the thickness direction to decrease the thickness to about 2.5 mm. The decreased thickness permits ease of folding of the filter medium 30. The nonwoven fabrics of the upper layer 31 and the lower layer 32 are intertwined with each other through the meshes of the reinforcing sheet 33 by needle punching work, by which the upper layer 31 and the lower layer 32 are integrated firmly so as not to be separated from each other. Preferably, there may be provided a process in which the filter medium 30 is impregnated with an adhesive. By impregnating the filter medium 30 with the adhesive, the intertwined nonwoven fabrics are solidified, by which the strength of the filter medium 30 can be improved. As the adhesive, butadiene rubber, phenolic resin, or ketone resin may be used.

FIG. 3 shows details of a state in which the filter medium 30 is folded.

For the filter medium 30 pleated and formed into a zigzag shape, if the number of folds per unit length, namely, the number of the peaks 30a and the valleys 30b is increased, in principle, the surface area of the filter medium 30 can be increased accordingly, and hence the filtration area can be increased. However, if a fold angle θ at the peak 30a and the valley 30b is too small, the adjacent surfaces of the folded filter medium 30 are brought into contact with each other, so that the area that effectively performs filtering action decreases accordingly.

For this filter medium 30, by holding a fold angle of at least four degrees, an unreasonable pressure applied to a mold used at the time of fold molding is inhibited, by which the mold can be prevented from being broken. The fold angle should preferably be within 90 degrees, more preferably within 45 degrees.

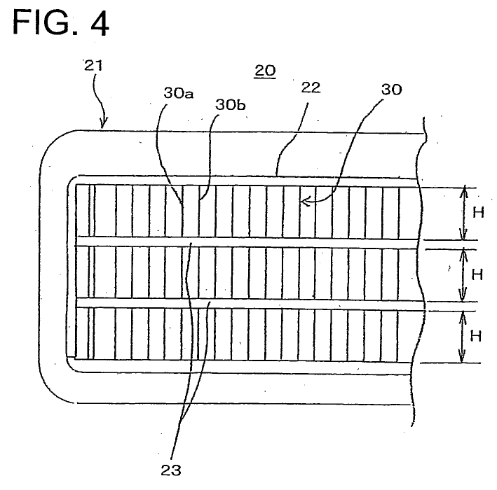

For the filter element 20 in which the zigzag-shaped filter medium 30 are held between the ribs 23 formed in the frame 21, it has been found that the interval between the ribs 23 exerts an influence as a factor of causing the increase in pressure loss. In FIG. 4, the interval between the ribs 23 is expressed as H.

In a case where the filter medium 30 having the peaks 30a and the valleys 30b formed so as to have an angle of four degrees or larger are used, the interval H of the ribs 23 should be 5 to 35 mm. If the interval H of the ribs 23 is in this range, the passage resistance at the time when oil passes through the filter medium 30 merely increases in proportion to the flow velocity, and the resistance is not increased by an adverse influence of other uncertain factors. Also, since the ribs 23 keep the shape of filter medium 30 surely, the filter medium 30 is prevented from sticking, and the increase in pressure loss is restrained, by which the flow rate of oil passing through the filter medium 30 is maintained. Therefore, in a case where the oil filter 1 is used for an automatic transmission, the operation of automatic transmission is maintained properly. Especially when the oil has a low temperature, the increase in pressure loss is inhibited effectively.

The upper limit of the interval H of the ribs 23 may be 30 mm, preferably 25 mm, and more preferably 20 mm.

### Experiment Example

The inventor of the present invention conducted the following test to check the degree of influence exerted on the passage resistance by a change of the interval H of the ribs 23.

In this test, the frame 21 formed so that the interval H of the ribs 23 of the frame 21 is different was prepared, and oil was allowed to pass through the filter medium 30 held by the frame 21. The flow velocity of oil passing through the filter medium 30 was changed, and the passage resistance of oil passing through the filter medium 30 was measured. As the frames 21 used in the test, frames in which the interval H of the ribs 23 was increased in increment of 5 mm in the range of 5 to 35 mm and the interval H was 3 mm were prepared. Further, for comparison, the filter medium 30 formed in a plane shape was prepared. Measurement was made on a total of nine kinds of samples.

The filter medium 30 used in the test was a filter medium in which a nonwoven fabric was compressed into a thickness of 2.5 mm, and was formed into a zigzag shape so that the peaks 30a and the valleys 30b were arranged alternately. The fold angle at the peak 30a and the valley 30b was four degrees.

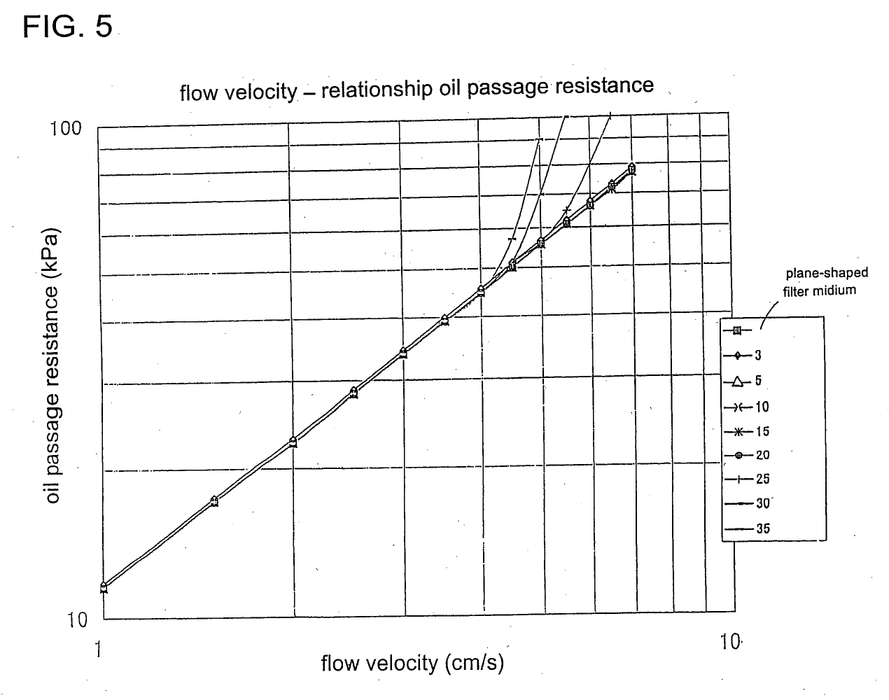

Table 1 summarizes the test results, and FIG. 5 is a graph showing the measurement results.

TABLE 1

| | | Flow velocity (cm/s) | | | | | | | | | | | | |
|---|---|---|---|---|---|---|---|---|---|---|---|---|---|---|
| | | 1 | 1.5 | 2.0 | 2.5 | 3.0 | 3.5 | 4.0 | 4.5 | 5.0 | 5.5 | 6.0 | 6.5 | 7.0 |
| Plane-shaped | | 11.5 | 17.1 | 22.6 | 28.2 | 33.7 | 39.1 | 44.6 | 50 | 55.5 | 60.9 | 66.3 | 71.7 | 77.1 |
| filter medium | | | | | | | | | | | | | | |
| Rib | 3 | 11.7 | 17.4 | 23.1 | 28.7 | 34.3 | 39.9 | 45.5 | 51.1 | 56.6 | 62.2 | 67.7 | 73.3 | 78.8 |
| interval | 5 | 11.6 | 17.2 | 22.8 | 28.4 | 34 | 39.5 | 45 | 50.5 | 56 | 61.4 | 66.9 | 72.3 | 77.8 |
| (mm) | 10 | 11.5 | 17.1 | 22.6 | 28.2 | 33.7 | 39.1 | 44.6 | 50 | 55.5 | 60.9 | 66.3 | 71.1 | 77.1 |
| | 15 | 11.5 | 17.1 | 22.6 | 28.2 | 33.7 | 39.1 | 44.6 | 50 | 55.5 | 60.9 | 66.3 | 71.1 | 77.1 |
| | 20 | 11.5 | 17.1 | 22.6 | 28.2 | 33.7 | 39.1 | 44.6 | 50 | 55.5 | 60.9 | 66.3 | 72 | 77.5 |
| | 25 | 11.5 | 17.1 | 22.6 | 28.2 | 33.7 | 39.1 | 44.6 | 51 | 56 | 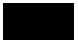 | 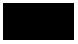 | 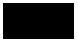 | |
| | 30 | 11.5 | 17.1 | 22.6 | 28.2 | 33.7 | 39.1 | 44.6 | 51.2 | 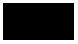 | 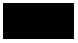 | | | |
| | 35 | 11.5 | 17.1 | 22.6 | 28.2 | 33.7 | 39.1 | 44.6 | 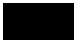 | 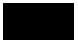 | | | | |

As a basis of the evaluation of test results, the following point must be considered.

For the filter medium 30 folded into a zigzag shape, it is thought that the surfaces of the adjacent portions stick to each other, so that the effective filtration area decreases. A cause for the occurrence of sticking of the filter medium 30 is a negative pressure produced by the flow of oil. The sticking phenomenon is caused by the increase in the negative pressure. Ideally, it is preferable that the frame 21 in which such a sticking phenomenon does not take place at all be used for the oil filter 1.

Even if it is necessary to design the oil filter 1 by considering the production of negative pressure, the degree of allowable negative pressure must be considered by taking the actual usage level into account. In this respect, in the oil filter 1 for an automatic transmission, taking account of the structure of a system in which oil flows, the highest negative pressure produced logically or physically is about −100 kPa. On the other hand, at the actual usage level, the highest negative pressure is produced when the engine is started in a cold district. The allowable negative pressure at this time is thought to be about −50 kPa. That is to say, it is sufficient to consider the load of 50 kPa at the actual usage level.

From this viewpoint, the test results are studied.

First, as is apparent from FIG. 5, for the plane-shaped filter medium, the passage resistance increases proportionally as the flow velocity changes. For this straight line, the passage resistance reaches 50 kPa when the flow velocity increases to about 4.5 cm/s. For the zigzag-shaped filter medium 30 as well, if the data lie on this straight line, the performance can be regarded as the same as that of the plane-shaped filter medium.

Viewing FIG. 5 from this point of view, for the frame 21 in which the interval H of the ribs 23 is 5 to 20 mm, the data approximately lie on the straight line shown in FIG. 5 with respect to all flow velocities changed in this test. Therefore, for the frame 21 in which the interval H of the ribs 23 is 5 to 20 mm, the performance can be regarded as the same as that of the plane-shaped filter medium, so that if the flow velocity is in the range up to about 4.5 cm/s at which the passage resistance reaches 50 kPa, the oil filter 1 can be used without problem.

By contrast, for the frame 21 in which the interval H of the ribs 23 is 25 mm, 30 mm and 35 mm, the passage resistance deviates gradually from the proportional straight line and increases suddenly as the flow velocity increases. Specifically, for the frame 21 in which the interval H of the ribs 23 is 25 mm, 30 mm and 35 mm, the passage resistance increases suddenly when the flow velocity exceeds 5.0 cm/s, 4.5 cm/s and 4.0 cm/s, respectively. These points correspond to the shaded data in Table 1.

Thus, for these frames 21, the sticking phenomenon of the filter medium 30 is caused as the flow velocity increases. Therefore, considering the comparison with the plane-shaped filter medium, it can be said that these frames 21 cannot be used for the oil filter 1. However, further considering the actual usage level, for the frame 21 in which the interval H of the ribs 23 is 25 mm and 30 mm, the load exceeds 50 kPa when the flow velocity exceeds 4.5 cm/s, so that if the flow velocity is in the range up to 4.5 cm/s, it can be said that these frames 21 can be used without problem.

On the other hand, for the frame 21 in which the interval H of the ribs 23 is 35 mm, the passage resistance exceeds 50 kPa, which is the allowable value at the actual usage level, when the flow velocity exceeds 4.0 cm/s. Therefore, it is unfavorable to use this frame 21 for the oil filter 1.

In contrast with these frames 21, for the frame 21 in which the interval H of the ribs 23 is 3 mm, the filter medium 30 is held firmly because of the small interval H of the ribs 23, so that the filter medium 30 does not stick. However, it was found that by the influence of excessively decreased interval H of the ribs 23, the pressure loss itself is increased, exceeding the plane-shaped filter medium specification, so that it is difficult to use this frame 21 even at the actual specification level.

From the above results, it can be concluded that for the zigzag-shaped filter medium 30 which is pleated so that the peaks 30a and the valleys 30b are arranged alternately, the frame 21 in which the interval H of the ribs 23 that hold the filter medium 30 is not smaller than 5 mm and smaller than 35 mm is preferably used.

The above explanation has been given by taking the filter medium formed by holding the reinforcing sheet between the nonwoven fabric layers as an example. However, the construction of the filter medium is not limited to the above-described construction. The present invention can be applied to a filter element using a filter medium consisting of nonwoven fabric only. Also, the number of ribs is not limited to two, and can be changed appropriately according to the area of the frame constituting the filter element. Also, the direction in which the filter medium is arranged is not limited to the direction in which the peaks and the valleys are arranged alternately in the direction in which the ribs extend. The filter medium may be arranged in the direction in which the peaks and the valleys are arranged alternately in the direction perpendicular to the direction in which the ribs extend.

The above explanation has been given by taking the case where the filter element is applied to an oil filter for an automatic transmission as an example. However, the application of the filter element is not limited to the above-described application. The present invention can be applied to a filter element used for other liquid filters.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2005-0027 filed on Jan. 31, 2005 including the specification, claims, drawings and summary is incorporated herein by reference in its entirety.

What is claimed is:

1. A filter element comprising a filter medium pleated so that peaks and valleys are arranged alternately and a frame for holding the filter medium,
the frame including a frame body forming the peripheral edge portion thereof and a plurality of ribs extending in parallel on the inside of the frame body;
the interval between the ribs being set at 5 to 35 mm; and
the filter medium being arranged between the ribs by being folded at an angle of at least four degrees at the peaks and the valleys.

2. The filter element according to claim 1, wherein the filter medium is held by the frame so that the peaks and the valleys are arranged alternately in the direction in which the ribs extend.

3. The filter element according to claim 1, wherein the filter medium is made up of a nonwoven fabric layer and a reinforcing layer for reinforcing the nonwoven fabric layer.
